(19) United States
(12) Patent Application Publication
(10) Pub. No.: US 2011/0077890 A1
(43) Pub. Date: Mar. 31, 2011

(54) METHOD FOR THERMALLY COMPENSATING A GAGING DEVICE AND THERMALLY COMPENSATED GAGING STATION

(76) Inventors: Bruno Zanetti, Malalbergo (BO) (IT); Matteo Aldrovandi, Bologna (IT); William Montanari, Castel Maggiore BO (IT)

(21) Appl. No.: 12/995,259

(22) PCT Filed: Jul. 9, 2009
(86) PCT No.: PCT/EP2009/058774

§ 371 Date: Nov. 30, 2010

(30) Foreign Application Priority Data
Jul. 11, 2008 (IT) BO2008A000432

(51) Int. Cl. G06F 19/00; G12B 13/00; G12B 7/00

(52) U.S. Cl. 702/94; 73/1.79

(57) ABSTRACT

Thermal drifts compensation method in a gaging device (1) with a transducer; the compensation method includes the steps of: determining and storing, in the course of a calibration operation, values of a thermal compensation coefficient (K) upon variation of a temperature (T) of the gaging device (1); detecting, in the course of a gaging operation, a current reading (X) of the gaging device (1); detecting, in the course of the gaging operation, a current temperature (T) of the gaging device (1); determining, in the course of the gaging operation, the current value of the thermal compensation coefficient (K) by means of the values of the thermal compensation coefficient (K) previously determined and stored in the course of the calibration operation as a function of both the current temperature (T) of the gaging device (1) and the current reading (X) of the gaging device (1); and correcting, in the course of the gaging operation, the current reading (X) of the gaging device (1) by means of the current value of the thermal compensation coefficient (K).

### TECHNICAL FIELD

The present invention relates to a method for thermally compensating a gaging device, and to a thermally compensated gaging station.

### BACKGROUND ART

The information provided by a gaging device such as a position sensor is affected, among other things, by the environmental temperature, since a temperature variation causes so-called thermal drifts caused by both unavoidable thermal deformations in the metal component parts of the position sensor, and unavoidable variations in the electrical resistance of the electric circuits of the position sensor. For attempting to render the sensor less sensitive to the temperature variations, the position sensor can be implemented with materials having limited thermal deformations and limited electrical resistance variations. However, it is not possible to obtain a gaging device which be totally insensitive to the effects of the temperature variations.

In the high accuracy gaging devices and sensors it is known to carry out a compensation of the reading provided by the sensor as a function of the environmental temperature. For example, US patent US5689447A1 discloses a gage head or position sensor of the LVDT type, i.e. including an “LVDT” (Linear Variable Differential Transformer”) inductive transducer, wherein there occurs a thermal compensation of the reading provided by the sensor which takes into consideration the influence of the environmental temperature. US patents US6844720B1 and US6931749B2 discloses further examples of thermal compensation of a position sensor of the LVDT type.

However, the known methods (for example of the same type as the one described in patent US5689447A1) for determining the value of the thermal compensation coefficient involve quite remarkable approximations, and thus they do not enable to achieve a very accurate compensation. As a consequence, the known methods can not be applied to gaging applications requiring an extremely high accuracy.

### DISCLOSURE OF THE INVENTION

Object of the present invention is to provide a method for thermally compensating a gaging device and a thermally compensated gaging station, which method and station do not present the above described disadvantages and can be easily and cheaply implemented.

According to the present invention there are provided a method for thermally compensating a gaging device and a thermally compensated gaging station according to what is claimed in the accompanying claims.

### BRIEF DESCRIPTION OF THE DRAWINGS

The present invention is now described with reference to the enclosed sheets of drawings, given by way of non limiting example, wherein:

FIG. 1 is a simplified front view, with some parts removed for sake of clarity, of a calibration station for a thermally compensated position sensor;

FIG. 2 is a simplified side view, with some parts removed for sake of clarity, of the calibration station of FIG. 1;

FIG. 3 is a graph showing the time variation of the temperature of a position sensor which is located in the calibration station of FIG. 1 during a phase of determining the value of a thermal compensation coefficient, and

FIG. 4 is a three dimensional graph showing an example of the values taken by a thermal compensation coefficient.

### BEST MODE FOR CARRYING OUT THE INVENTION

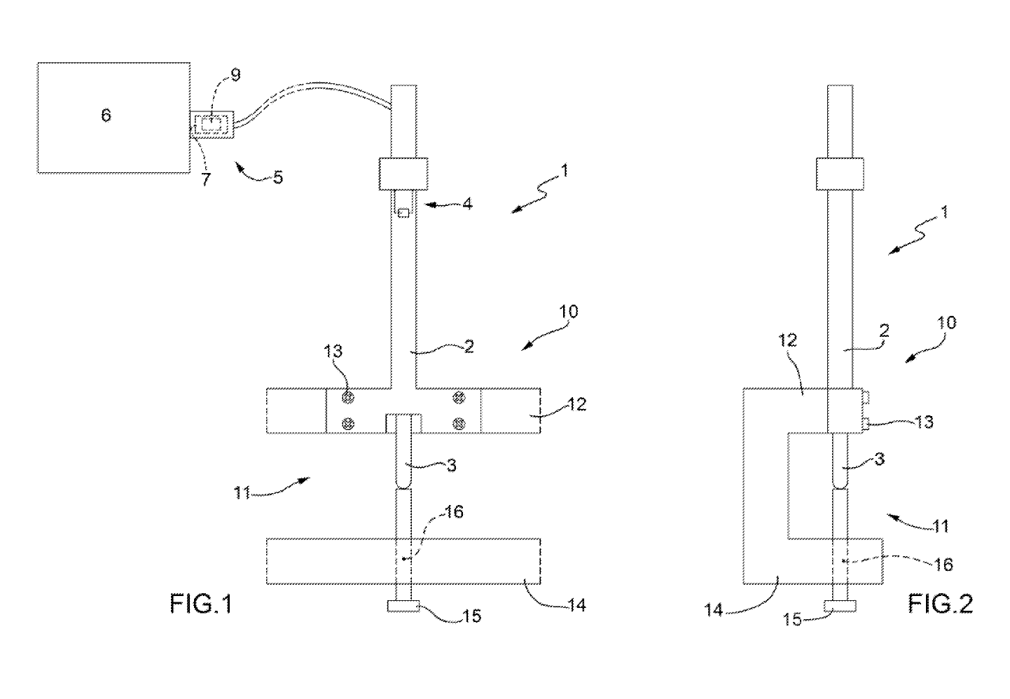

In FIG. 1, the reference number 1 indicates, on the whole, a gaging device, e.g. a position sensor including a linear transducer of the LVDT (Linear Variable Differential Transformer) type, for instance of the same type as the one described in US patent US6931749B1. The gaging device or position sensor 1 includes a stationary part 2 and a movable element, more specifically a slider 3, which carries a feeler and is movable with respect to the stationary part. The transducer of the position sensor 1 includes windings and a movable core (per se known and thus not illustrated in the attached sheets of drawings), connected to the stationary part 2 and to the movable element or slider 3, respectively, and is adapted for providing an alternating electrical signal which has a variable intensity voltage and depends on the position of the movable slider 3. The windings of the transducer of the position sensor 1 are part of an electric circuit which is schematically shown in FIG. 1 with the reference number 4, is fed with an alternating electrical voltage, and has a variable inductance depending on the position of the movable slider 3.

The position sensor 1 includes a coupling cable and an electrical connector 5, which is employed for forming an electrical connection between the transducer and a gaging unit 6 being adapted to detect the reading provided by the transducer of the position sensor 1 in order to determine the exact position of the slider 3 of the position sensor 1. The gaging device or position sensor 1 and the corresponding gaging unit 6, taken as a whole, form a gaging station.

The electrical connector 5 also includes a digital memory 7, which can be read by the gaging unit 6. Preferably, the digital memory 7 is fixed to the connector 5 in a permanent way (that is, the former is integrated in the connector 5 in a non-separable way). The electrical connector 5 includes a pair of feed terminals for feeding the position sensor 1 with an alternating feed voltage, a pair of analogue terminals providing an alternating electrical signal which has a variable intensity voltage and depends on the position of the movable slider 3, and a pair of digital terminals that can be used for reading the content of the digital memory 7. Obviously, the three pairs of terminals can share a single earth terminal, and thus there can be just four different terminals. According to different embodiments herein not illustrated, the digital memory 7 can be permanently connected to the casing or to another part of the sensor 1, and/or it can include a wireless communication device, based for example on the transponder technology, for enabling to communicate with the gaging unit 6; in this latter embodiment the digital terminals can be obviously omitted.

The gaging unit 6 is adapted for determining a value of a thermal compensation coefficient K as a function of both the current temperature T of the position sensor 1 and the reading X of the position sensor 1 (that is, of the position of the slider 3 of the position sensor 1). In order to perform a correct reading of the position of the slider 3 of the position sensor 1, the gaging unit 6 detects the reading X of the position sensor 1, detects the current temperature T of the position sensor 1, determines a current value of the thermal compensation coefficient K and compensates the reading X of the position sensor 1 by applying the current value of the thermal compensation coefficient K. It is important to point out that the thermal compensation coefficient K can be of the additive type, which means that it can be algebraically added to the reading X of the position sensor 1, or it can be of the multiplicative type, which means that the reading X of the position sensor 1 can be multiplied by it.

According to a preferred embodiment, the gaging unit 6 detects the current temperature T of the position sensor 1 as a function of the current electrical resistance of the electric circuit 4 of the transducer of the position sensor 1; in other words, the gaging unit 6 feeds the electric circuit 4 of the transducer of the position sensor 1 with a direct feed voltage which enables to determine a value of the current electrical resistance of the electric circuit 4 and does not affect in any way the alternating electrical signal which has a variable intensity voltage depending on the position of the movable slider 3.

The digital memory 7 stores a table 9 of the compensation coefficient K including a plurality of triads of values, each of them providing the value of the compensation coefficient K at a determined value of the temperature T of the position sensor 1 and at a determined value of the reading X of the position sensor 1. According to a possible embodiment, the table 9 of the compensation coefficient K includes twenty determined triads of values each triad indicating the value of the compensation coefficient K in correspondence of one out of four different values of temperature T of the position sensor 1 (typically 10° C., 20° C., 30° C., and 40° C.) and of one out of five different values of the reading X of the position sensor 1. The five different values of the reading X of the position sensor 1 correspond to two end positions of the position sensor 1, to a central position of the position sensor 1, and to two intermediate positions of the position sensor 1, each of the latter being comprised between the central position of the position sensor 1 and a respective end position of the position sensor 1.

When the current temperature T of the position sensor 1 is comprised between two adjacent values in the table 9, and/or the current reading X of the position sensor 1 is comprised between two adjacent values in the table 9, a mathematical interpolation operation is carried out (for example using Lagrange polynomials) for calculating the value of the corresponding compensation coefficient K.

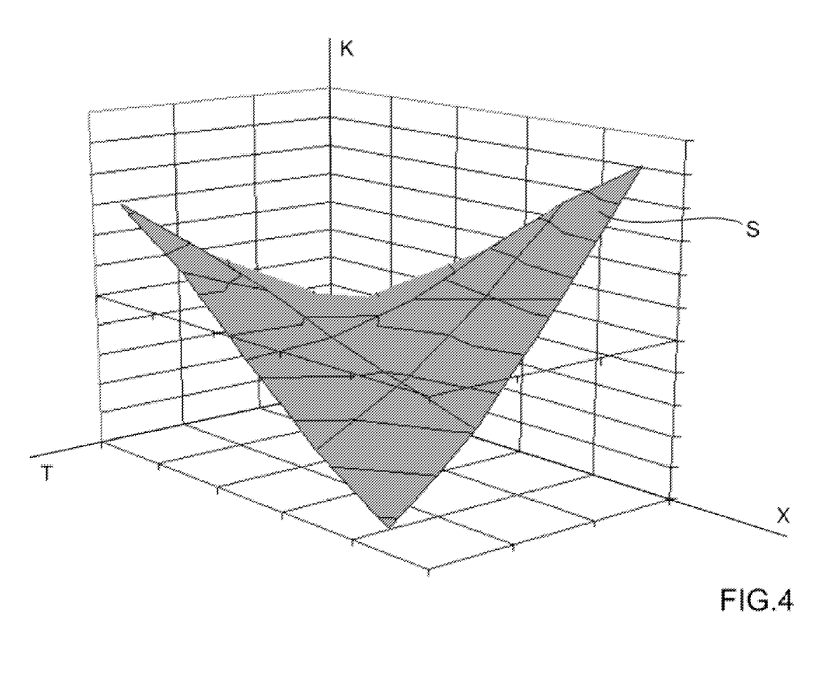

In the graph of FIG. 4, the triads of values of the table 9 correspond to the points of a surface S enabling to identify the compensation coefficient K to be used for thermally compensating a certain reading X of the position sensor 1 at a certain temperature T.

The table 9 of the compensation coefficient K can be generated for each position sensor 1. In this way, the values of the compensation coefficients K included in the table 9 are more accurate, since they take into consideration all the specific features of the single position sensor 1, but the downside is that it is necessary to undergo each position sensor 1 to a calibration operation. As an alternative, the table 9 of the compensation coefficient K can be generated for a certain family of position sensors 1. In this way it is not necessary to undergo each position sensor 1 to a specific calibration operation, but the values of the compensation coefficients K included in the table 9 show average values of the specific family of position sensors 1 instead of the actual values of each position sensor 1.

According to an equivalent embodiment, the digital memory 7 does not store the values of the single triads of values of the compensation coefficients K, but it stores values of parameters of a function (for example a polynomial function) which interpolates the triads of values of the compensation coefficients K. This function is adapted to provide the value of the compensation coefficient K as a function of both the value of the temperature T of the position sensor 1 and the reading X of the position sensor 1.

A calibration operation for generating the table 9 of the compensation coefficient K is described herebelow.

For generating the table 9 of the compensation coefficient K, the position sensor 1 is located in a calibration station 10 which is housed inside a climatic chamber wherein the environmental temperature can be very accurately adjusted. The calibration station 10 includes a C-shaped locking device 11 comprising an upper element 12 to which the stationary part 2 of the position sensor 1 is fixed by means of screws 13, and a lower element 14 cooperating with the slider 3 of the position sensor 1. In particular, the lower element 14 includes a screw 15 which is screwed through a threaded through hole 16 and forms an abutment against which a free end of the slider 3 of the position sensor 1 leans. By screwing and unscrewing the screw 15 into the hole 16, the axial position of the screw 15 varies, and thus the relative position between the slider 3 of the sensor position 1 and the stationary part 2 varies, too.

It should be noted that the screw 15 enables to lock the position sensor 1 (that is, the slider 3 of the position sensor 1) at a desired calibrating position.

Once the position sensor 1 has been located in the calibration station 10, at each predetermined calibration position the readings X of the position sensor 1 that will be inserted in the triads of values of the table 9 of the compensation coefficient K are detected. More specifically, the position sensor 1 (that is, the slider 3 of the position sensor 1) is located and locked at each predetermined calibration position which is identified by means of the reading X of the position sensor 1. It is not necessary to exactly locate and lock the position sensor 1 at each predetermined calibration position (this would be a very difficult operation since an accuracy in the order of micron is required), but it is sufficient to locate and lock the position sensor 1 in a neighborhood of the predetermined calibration position. For this reason, once the position sensor 1 has been located and locked at a predetermined calibration position, the correspondent reading X of the position sensor 1 is subsequently detected at a known and predetermined reference temperature T_{ref}—as described hereinafter in more detail—for determining the actual calibration position (which is comprised in a neighborhood of the predetermined calibration position, but which exactly corresponds to the predetermined calibration position just in rare and accidental cases).

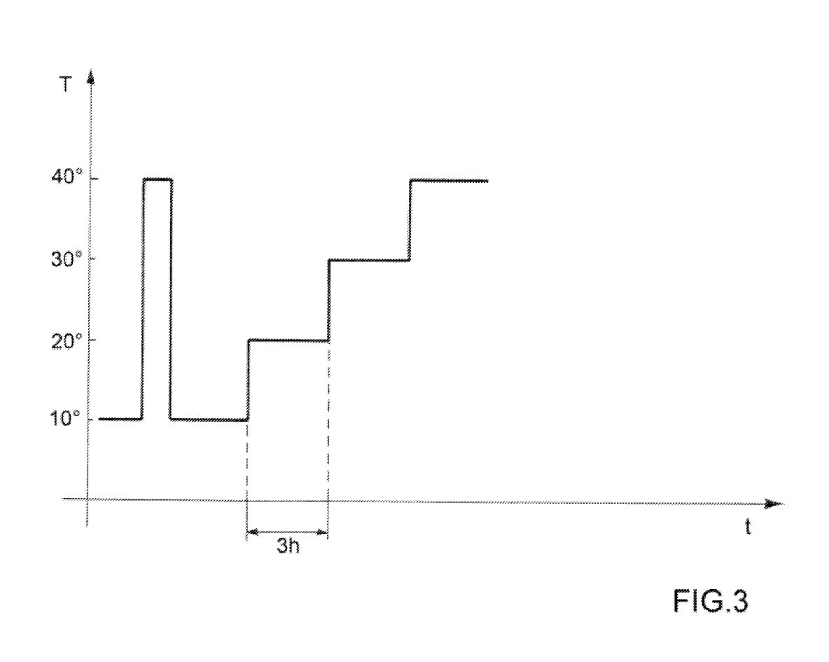

Once the position sensor 1 (that is the slider 3 of the position sensor 1) is located and locked at one of the predetermined calibration positions, first of all the corresponding reading X of the position sensor 1 is detected at the temperature T_{ref} of the position sensor 1; in other words, the temperature T of the position sensor 1 (that is the internal temperature of the climatic chamber housing the calibration station 10) is adjusted so as to be equal to the reference temperature T_{ref}, as already stated hereinbefore, and when the current temperature T of the position sensor 1 is equal to the reference temperature T_{ref} and is in steady state, there is detected the value of the reading X of the position sensor 1 at the reference temperature T_{ref}. Subsequently, the temperature T of the position sensor 1 (which means the internal temperature of the climatic chamber housing the calibration station 10) is varied step by step so that the current temperature T of the position sensor 1 takes all the preset values (typically 10° C., 20° C., 30° C., and 40° C.) in steady state. FIG. 3 is a graph showing an example of the step-by-step time variation of the current temperature of the position sensor 1 located in the calibration station 10. Preferably each value of the current temperature T of the position sensor 1 is maintained for three hours so that all the components of the position sensor 1 can be thermally settled down. At each step of the current temperature T of the position sensor 1 and when the current temperature T of the position sensor 1 is in steady state, the value of the reading X of the position sensor 1 is detected, and by comparing the latter with the reading X of the position sensor 1 at the reference temperature T_{ref}, the value of the compensation coefficient K is determined. In this way there are determined the three values of the temperature T, the reading X of the position sensor 1 and the compensation coefficient K for generating a corresponding triad of values. More specifically, the triad of values is determined at the end of the step of the current temperature T of the position sensor 1, which means when the thermal settling down of all the components of the position sensor 1 has occurred. According to a preferred embodiment of the present invention, the coefficient K is of the additive type, it has a mathematical sign (which means it can be a positive or a negative value) and it is calculated as the difference between the reading X of the position sensor 1 at the current temperature and the reading X of the position sensor 1 at the reference temperature T_{ref}.

Once the step-by-step time variation of the current temperature of the sensor position 1 has ended, the position sensor 1 (that is, the slider 3 of the position sensor 1) is located at a new predetermined calibration position that is detected by a new reading X of the position sensor 1 at the reference temperature T_{ref} until all the predetermined calibration positions are completed. According to a preferred embodiment which is illustrated in detail in the graph of FIG. 3, once the position sensor 1 (that is, the slider 3 of the position sensor 1) has been located in a calibration position, the position sensor 1 is subjected to a thermal settling cycle so that the temperature T of the position sensor 1 varies between the preset minimal value and the preset maximal value (which means between 10° C. and 40° C.). The object of said thermal settling cycle is to enable a settling of the mechanical hysteresis of all the components of the position sensor 1. Moreover, according to a preferred embodiment, the current temperature T of the position sensor 1 is detected as a function of the current electrical resistance of the electric circuit 4 of the transducer of the position sensor 1. More specifically, the electric circuit 4 of the transducer of the position sensor 1 is fed with a continuous feed voltage which enables to determine a value of the current electrical resistance of a component of the electric circuit 4. This does not affect in any way the alternating electrical signal the intensity voltage of which can vary depending on the position of the movable slider 3. It should be noted that the current temperature T of the position sensor 1 is detected as a function of the current electrical resistance of the electric circuit 4 of the transducer of the position sensor 1 during both the calibration operation for generating the table 9 of the compensation coefficient K and the actual working of the position sensor 1. In this way, by using the same method and the same components for detecting the current temperature T of the position sensor 1, possible systematic errors introduced during the detection of the current temperature T of the position sensor 1 similarly repeat during both the generation of the compensation coefficients K and the usage of the compensation coefficient K, and thus they do not affect the proper thermal compensation proceeding.

According to a different embodiment, the current temperature T of the position sensor 1 can be detected by means of a temperature sensor (for instance a thermistor or a thermocouple) which is separate and independent from the electric circuit 4, and can be fixed to the stationary part 2 of the position sensor 1.

In the above described example, the gaging device is a position sensor 1 having a feeler carried by an axially movable slider 3 and including an inductive linear transducer of the LVDT type. According to possible alternative embodiments of the invention, the gaging device can have different mechanical features and/or can include an inductive linear transducer of a different kind (for example a “Half Bridge” or HBT transducer) or a non-inductive linear transducer. As a possible mechanical alternative, a feeler can be carried by a movable element adapted to pivot about a fulcrum with respect to a stationary part, substantially as shown in the gaging head of the above mentioned patent US5689447.

The above described compensation method provides many advantages since it can be easily and cheaply implemented, and, above all, it enables to obtain a very accurate compensation which can be also applied to gaging applications requiring an extremely high accuracy.

1. A method for thermally compensating a gaging device, the method including the following steps:
determining and storing, during a calibration operation, values of a thermal compensation coefficient upon variation of a temperature of the gaging device;
detecting, during a gaging operation, a current reading of the gaging device;
detecting, during the gaging operation, a current temperature of the gaging device;
determining, during the gaging operation, a current value of the thermal compensation coefficient, as a function of the current temperature of the gaging device and as a function of the current reading of the gaging device, by means of said values of the thermal compensation coefficient previously determined and stored during the calibration operation; and
correcting, during the gaging operation, the current reading of the gaging device by means of the current value of the thermal compensation coefficient.

2. The method according to claim 1, including a further step of generating, during the calibration operation, a table of values of the thermal compensation coefficient which comprises a plurality of triads of values, each of said triads of values providing the value of the compensation coefficient at a determined value of the temperature of the gaging device and at a determined value of the reading of the gaging device.

3. The method according to claim 2, wherein the step of generating, during the calibration operation, the table of values of the compensation coefficient includes further steps of:
causing controlled variations of the temperature of the gaging device;
detecting, when the gaging device is arranged at a plurality of predetermined calibration positions, variations of the reading of the gaging device at a plurality of predetermined temperatures and with respect to a reference temperature; and
employing each detected variation of the reading of the gaging device in order to obtain the value of the thermal compensation coefficient associated with the corresponding reading of the gaging device and the corresponding temperature of the gaging device.

4. The method according to claim 3, including a further step of defining the predetermined calibration positions of the gaging device on the basis of the reading of the gaging device at the reference temperature.

5. The method according to claim 2, including a further step of storing the table of values of the compensation coefficient in a digital memory of the gaging device.

6. The method according to claim 5, including a further step of arranging the digital memory which comprises the table of values of the compensation coefficient within an electrical connector of the gaging device.

7. The method according to claim 2, including a further step of performing, during the gaging operation, a mathematical interpolation operation for calculating the current value of the compensation coefficient, when the current temperature of the gaging device is comprised between two adjacent values in said table, and/or when the current reading of the gaging device is comprised between two adjacent values in said table.

8. The method according to claim 2, wherein the step of generating, during the calibration operation, the table of values of the compensation coefficient includes further steps of:
defining at least two predetermined calibration positions;
placing and locking the gaging device at each predetermined calibration position;
varying the temperature of the gaging device step by step to at least two preset temperature values; and
determining the value of the current temperature of the gaging device, the value of the current reading of the gaging device, and the value of the compensation coefficient in order to generate a corresponding triad of values,
wherein the step of varying the temperature of the gaging device occurs in such a way that the temperature of the gaging device is in steady state at a time when the values of the current temperature, the value of the current reading and the value of the compensation coefficient are determined.

9. The method according to claim 8, wherein the step of generating, during the calibration operation, the table of values of the compensation coefficient includes a further step of subjecting, once the gaging device has been arranged at one of said predetermined calibration positions, the gaging device to a thermal settling cycle in which the temperature of the gaging device is varied between a preset minimum value and a preset maximum value.

10. The method according to claim 8, wherein the step of determining, during the calibration operation, the value of the current temperature of the gaging device includes the further steps of:
determining a current electrical resistance of an electric circuit of a transducer of the gaging device; and
determining said value of the current temperature of the gaging device as a function of the current electrical resistance of the electric circuit of the transducer of the gaging device.

11. The method according to claim 10, wherein the step of detecting, during the gaging operation, the current temperature of the gaging device includes the further steps of:
determining a current electrical resistance of an electric circuit of the transducer of the gaging device; and
determining said current temperature of the gaging device as a function of the current electrical resistance of the electric circuit of the transducer of the gaging device.

12. A thermally compensated gaging station including:
a gaging device with a stationary part, a movable element and a transducer that is adapted to provide an electrical signal depending on the position of the movable element;
a gaging unit for detecting, during a gaging operation, a current reading of the gaging device and a current temperature of the gaging device, for determining, during the gaging operation, a current value of a thermal compensation coefficient by utilizing values of the thermal compensation coefficient previously determined and stored during a calibration operation, and for correcting, during the gaging operation, the current reading of the gaging device by means of the current value of the thermal compensation coefficient,
wherein the gaging unit determines, during the gaging operation, the current value of the thermal compensation coefficient as a function of the current temperature of the gaging device and as a function of the current reading of the gaging device.

13. The gaging station according to claim 12, further including a digital memory which stores a table of values of the compensation coefficient including a plurality of triads of values, each triad of values providing the value of the compensation coefficient at a determined value of the temperature of the gaging device and at a determined value of the reading of the gaging device.

14. The gaging station according to claim 13, wherein said digital memory is arranged in an electrical connector of the gaging device.

15. The gaging station according to claim 12, wherein the gaging unit determines, during the gaging operation, the current temperature of the gaging device as a function of the current electrical resistance of an electric circuit of the transducer of the gaging device.

16. The gaging station according to claim 12, wherein said movable element of the gaging device is a slider that is axially movable with respect to the stationary part.
